(19) United States
(12) Patent Application Publication
(10) Pub. No.: US 2014/0078918 A1
(43) Pub. Date: Mar. 20, 2014

(54) DYNAMIC POWER-SAVING APPARATUS AND METHOD FOR MULTI-LANE-BASED ETHERNET

(71) Applicant: Electronics and Telecommunications Research Institute, Daejeon (KR)

(72) Inventors: Kyeong-Eun HAN, Daejeon-si (KR); Sun-Me KIM, Daejeon-si (KR); Jong-Hyun LEE, Daejeon-si (KR)

(73) Assignee: Electronics and Telecommunications Research Institute, Daejeon (KR)

(21) Appl. No.: 13/952,948

(22) Filed: Jul. 29, 2013

(30) Foreign Application Priority Data
Sep. 17, 2012 (KR) 10-2012-0102941

(51) Int. Cl. H04L 12/861

(52) U.S. Cl. CPC H04L 49/90
USPC 370/252

(57) ABSTRACT

Provided are a power-saving apparatus and method for multi-lane-based Ethernet, which allow a multi-lane-based Ethernet apparatus to improve energy-conserving efficiency while minimizing the deterioration of the performance of a network. The power-saving apparatus includes: a multi-lane communication unit configured to distribute an input communication packet between a plurality of transmission lanes, photoelectrically convert the input communication packet and transmit the photoelectrically-converted communication packet; a multi-buffer unit configured to comprise one or more buffers, store the input communication packet in each active buffer and transmit the input communication packet to the multi-lane communication unit; and a control unit configured to monitor the multi-buffer unit, compare the size of memory space in use of the multi-buffer unit with a predefined threshold and switch the one or more buffers to an active or inactive state based on the results of the comparison.

### CROSS-REFERENCE TO RELATED APPLICATION(S)

This application claims the benefit under 35 U.S.C. §119(a) of Korean Patent Application No. 10-2012-0102941, filed on Sep. 17, 2012, in the Korean Intellectual Property Office, the entire disclosure of which is incorporated herein by reference for all purposes.

### BACKGROUND

1. Field

The following description relates to a multi-lane-based Ethernet apparatus for high-speed transmission, and more particularly, to an energy-saving buffer configuring apparatus and method of a multi-lane-based Ethernet apparatus.

2. Description of the Background

Under the influence of fusion of different types of communication environments and digital fusion, rapid growth of multimedia communication service has come to require a high-speed broadband transmission system. Accordingly, there is an increasing need for high-speed Ethernet transmission technology that supports a data rate of tens of gigabits or more.

The high-speed Ethernet transmission technology includes techniques employing a multi-lane structure. The multi-lane structure includes a group of several lanes (for example, 40 G/100 G lanes) having a lower transmission rate in order to establish a link having a high transmission rate, i.e., a single aggregated high-speed link. For example, an Ethernet transmission system having a high data transmission rate can be built by processing data transmitted from a media access control (MAC) layer to a physical (PHY) layer at a transmission rate of 100 gigabits using ten lanes each having a transmission rate of 10 gigabits for 100 gigabit Ethernet. With this structure, a high-speed transmission system can be implemented which can yield valuable effects using a plurality of inexpensive elements.

However, the power consumption of various network equipment is on the rapid increase, in part, due to the development of high-speed Ethernet technology and increases in the sizes and numbers of servers and data. Accordingly, public attention has been increasingly drawn worldwide to methods to provide energy-conserving, low power consumption Ethernet techniques, and the development and standardization of such techniques are under way. In the case of Ethernet, in particular, the Energy Efficient Ethernet standard for copper-based 10 G Ethernet was completed in 2010 as Institute of Electrical and Electronics Engineers (IEEE) 802.3az. Currently, energy conservation-type Ethernet switches into which the IEEE 802.3az standard is reflected have been commercialized by various manufacturers such as Hewlett Packard (HP), Broadcom, Dell, etc.

High-speed Ethernet technology has been standardized as IEEE 802.3ba, but the corresponding standard does not disclose any conserving energy features. In general, as the speed of a network increases, the power consumption of communication devices significantly increases. Thus, there is a need for an energy conservation technique for high-speed Ethernet. According to the IEEE 802.3ba standard, a multi-lane structure is employed for high-speed Ethernet. A multi-lane structure is a structure in which a plurality of lanes having a relatively low transmission rate are used to form a single high-speed transmission link. According to the IEEE 802.3 standards, four electrical lanes and ten optical lanes are configured between a physical coding sublayer (PCS) layer and a physical medium attachment (PMA) layer. The electrical lanes correspond to a plurality of optical lanes through the PMA layer to transfer data. In the meantime, for an energy-conserving multi-lane-based high-speed Ethernet, various techniques to turn on or off electrical lanes, optical lanes, PCS lanes and transmission/reception devices have been suggested. Those techniques intend to improve energy efficiency by turning off the power of resources in response to there not being much transmission traffic. However, since there is a tradeoff between energy conservation and network performance, a method is needed to minimize the deterioration of network performance while maximizing energy conservation.

In a multi-lane-based Ethernet, a plurality of transmission lanes may be dynamically turned on or off so as to conserve energy. In this case, however, packet loss may occur during the turning on of the optical element of each transmission line due to an increase in the amount of traffic. To address this problem, high-speed storage devices such as buffers capable of temporarily storing communication packets to be transmitted are needed. However, in related art, buffers are always on regardless of the amount of traffic and thus continue to consume power. Therefore, energy conservation may be achieved by dynamically operating buffers in accordance with the circumstances of a network, instead of turning on the buffers all the time.

### SUMMARY

The following description relates to a power-saving apparatus and method for multi-lane-based Ethernet, which allow a multi-lane-based Ethernet apparatus to improve energy-conserving efficiency while minimizing the deterioration of the performance of a network.

In one general aspect, a power-saving apparatus for multi-lane-based Ethernet includes: a multi-lane communication unit configured to distribute an input communication packet between a plurality of transmission lanes, photoelectrically convert the input communication packet and transmit the photoelectrically-converted communication packet; a multi-buffer unit configured to comprise one or more buffers, store the input communication packet in each active buffer and transmit the input communication packet to the multi-lane communication unit; and a control unit configured to monitor the multi-buffer unit, compare the size of memory space in use of the multi-buffer unit with a predefined threshold and switch the one or more buffers to an active or inactive state based on the results of the comparison.

In another general aspect, a power-saving method for multi-lane-based Ethernet using one or more buffers, includes: monitoring the state of each of the buffers and the amount of memory space in use of each active buffer; determining whether to increase or reduce a number of active buffers among the one or more buffers by comparing the size of memory space in use of each active buffer with a predefined threshold; and adjusting the number of active buffers by selectively switching the one or more buffers between an active state and an inactive state through an on-off control based on the results of the determining .

Other features and aspects may be apparent from the following detailed description, the drawings, and the claims.

### BRIEF DESCRIPTION OF THE DRAWINGS

FIG. 1 is a diagram illustrating an example of a dynamic power-saving apparatus for multi-lane-based Ethernet.

FIG. 2 is a diagram illustrating an example of a multi-buffer unit illustrated in FIG. 1.

FIG. 3 is a diagram illustrating an example of a multi-lane communication unit illustrated in FIG. 1.

FIG. 4 is a flowchart illustrating an example of a dynamic power-saving method for multi-lane-based Ethernet.

FIG. 5 is a flowchart illustrating an example of a method to determine whether to increase or reduce the number of buffers.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

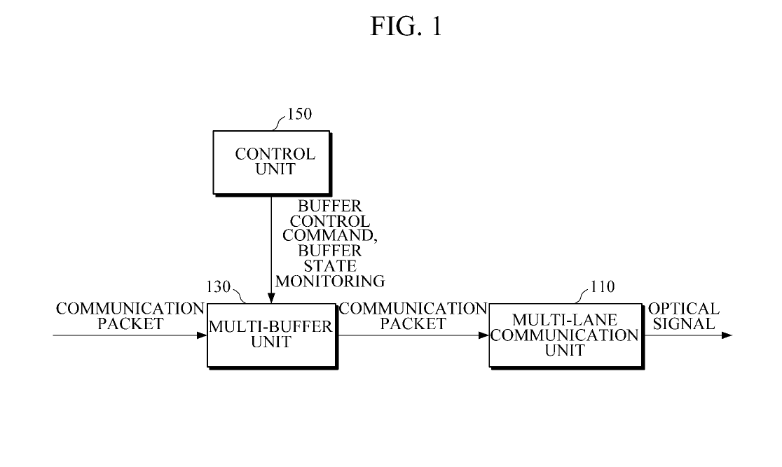

FIG. 1 is a diagram illustrating an example of a dynamic power-saving apparatus for multi-lane-based Ethernet.

Referring to FIG. 1, a dynamic power-saving apparatus for multi-lane-based Ethernet includes a multi-lane communication unit 110, a multi-buffer unit 130 and a control unit 150.

The multi-lane communication unit 110 includes a plurality of transmission lanes. The multi-lane communication unit 110 distributes a communication packet or data received from the multi-buffer unit 130 between the transmission lanes, photoelectrically converts the communication packet or data, and transmits the photoelectrically-converted communication packet or data to a reconciliation sublayer (RS) of a receiving party.

The multi-lane communication unit 110 dynamically operates the number of transmission lanes available for use in transmitting data in accordance with the traffic circumstances of a network. More specifically, when communication traffic is low due to a low use of channels, some transmission lanes may be switched off, and data may be transmitted via other normal transmission lanes. Then, when communication traffic becomes high due to an increasing use of channels, the switched-off transmission lanes may be switched back on, thereby increasing the number of transmission lanes available for use.

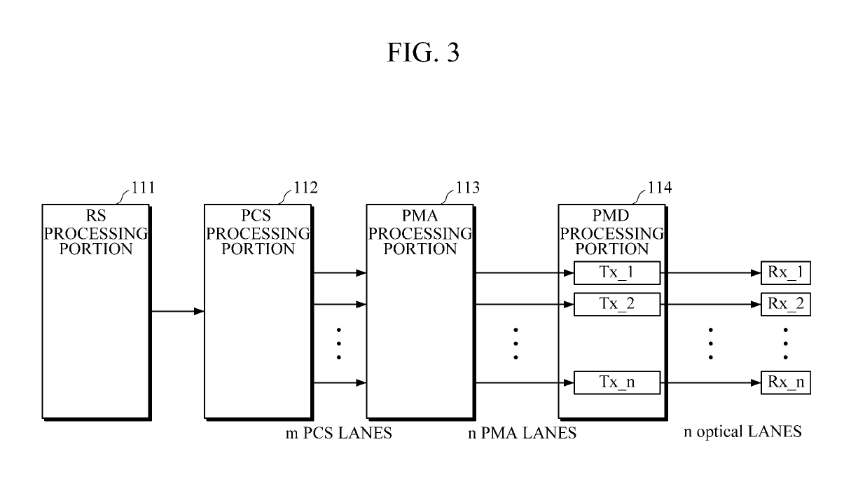

The multi-lane communication unit 110, unlike a typical communication device switching a communication network by means of an electric device, uses optical communication. To switch on a transmission lane, it is necessary to turn on a laser device in an optical transmitter of the transmission lane. In general, it generally takes a longer period of time (for example, about 100 ms) to reactivate an optical transmitter than to reactivate an electric transmitter. As a result, more data may be lost during the turn-on period of an optical transmitter than during the turn-on period of an electric transmitter. Such data loss may be reduced by one or more buffers included in the multi-buffer unit 130. The structure of the multi-lane communication unit 110 will be described later in further detail with reference to FIG. 3.

The multi-buffer unit 130 may include one or more buffers having the same size or different sizes. The multi-buffer unit 130 is located in an upper layer of the reconciliation sublayer (RS) of the multi-lane communication unit 110. The multi-buffer unit 130 temporarily stores data transmitted via the multi-lane communication unit 110. More specifically, when the amount of data transmitted via the multi-lane communication unit 110 increases, the multi-buffer unit 130 may temporarily store data intended to be transmitted via a transmission lane currently not in use, while the optical transmitter of the transmission lane switches on a laser device thereof. Then, in response to the transmission lane being turned on so as to become available for use, the multi-buffer unit 130 may transmit the temporarily-stored data to a receiving party via the multi-lane communication unit 110.

The multi-buffer unit 130 may flexibly use one or more buffers according to network circumstances (such as channel usage rate or data transmission rate). The multi-buffer unit 130 may not necessarily use two or more buffers all the time. Rather, the multi-buffer unit 130 may adjust the number of buffers in use according to the circumstances of each transmission lane. The multi-buffer unit 130 may activate or inactivate two or more buffers through on-off control in response to the receipt of a control command.

The greater the number of transmission lanes not in use, the larger the amount of traffic to be buffered, the larger the amount of data lost, and the greater the number of buffers required. On the other hand, the greater the number of transmission lanes in use, the less the number of buffers required.

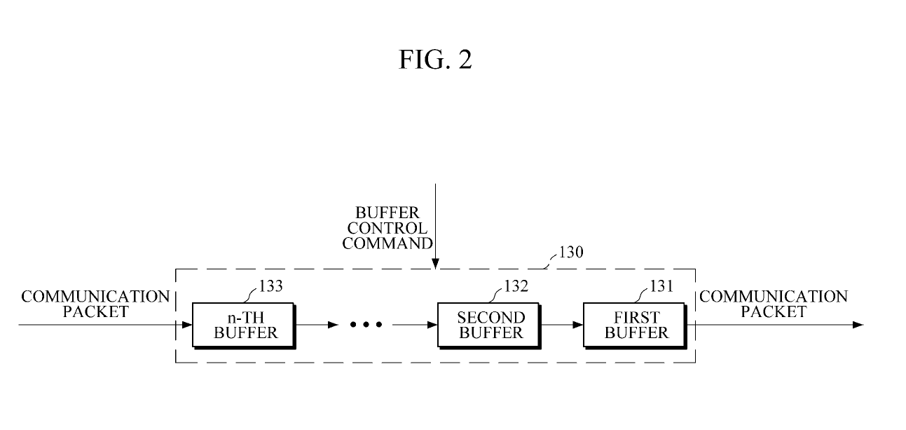

The multi-buffer unit 130 may flexibly adjust the number of buffers to be used according to network circumstances. Accordingly, the power consumption of a network can be reduced, and the energy efficiency of a network can be improved. The multi-lane buffer unit 130 will be described later in further detail with reference to FIG. 2.

The control unit 150 may monitor the transmission lanes of the multi-lane communication unit 110, the state of a network or the multi-buffer unit 130, and may transmit a control command for activating or deactivating the buffers of the multi-buffer unit 130 based on the results of the monitoring. The control unit 150 may periodically transmit the control command depending on traffic circumstances, the state of the buffers of the multi-buffer unit 130 or the quality of services to be provided.

More specifically, the control unit 150 monitors the multi-buffer unit 130, and identifies the number of buffers currently being active, the number of buffers currently being inactive, the order in which the active buffers have been activated, and the available memory capacity of each of the buffers of the multi-buffer unit 130. Then, the control unit 150 decides whether to increase or reduce the number of active buffers by comparing the available memory capacity of each of the buffers of the multi-buffer unit 130 with a predefined threshold, and transmits a control command to increase or reduce the number of active buffers to the multi-buffer unit 130. The predefined threshold may be set in consideration of the memory capacity of each of the buffers of the multi-buffer unit 130, the state of a network and the quality of services.

The control unit 150 may control the buffers of the multi-buffer unit 130 by means of various algorithms. A method to control the buffers of the multi-buffer unit 130 will hereinafter be described in detail with reference to FIG. 2.

FIG. 2 is a diagram illustrating an example of the multi-buffer unit 130.

Referring to FIG. 2, the multi-buffer unit 130 may include one or more buffers for use in queuing data, and each of the buffers may be activated or inactivated through an on/off control. In a case in which the multi-buffer unit 130 uses a single buffer, a queue may be turned on or off depending on network circumstances for conserving energy.

The multi-buffer unit 130 may include two or more buffers sharing the same storage space or having different storage spaces.

The buffers of the multi-buffer unit 130 may be activated or inactivated by an on-off control in accordance with a control command received from the control unit 150.

One or more queues may be activated at an early stage of the operation of the multi-buffer unit 130. A communication packet may be queued by a most recently added (or activated) buffer of the multi-buffer unit 130, and queues may be connected to one another so that they can operate together as if they were a single queue. For example, if the multi-buffer unit 130 uses a first buffer 131 only, a communication buffer may be input to the first buffer 131.

In a case in which the multi-buffer unit 130 uses two buffers, i.e., the first buffer 131 and a second buffer 132, a communication packet may be input to the second buffer 132, and may then be output from the second buffer 132 via the first buffer 131. That is, in a case in which the multi-buffer unit 130 uses n buffers, a communication packet may be input to an n-th buffer 133 and may be output from the first buffer 131 via each of the buffers between the first buffer 131 and the n-th buffer 133.

A data path for transmitting an input communication packet may be formed to directly connect each of the buffers of the multi-buffer unit 130, and a determination can be made as to via which buffers a communication packet is to be transmitted. For example, a communication packet may be directly transmitted only to active buffers while skipping inactive buffers.

FIG. 3 is a diagram illustrating an example of the multi-lane communication unit 110.

Referring to FIG. 3, the multi-lane communication unit 110 includes a reconciliation sublayer (RS) processing portion 111, a physical coding sublayer (PCS) processing portion 112, a physical medium attachment (PMA) processing portion 113 and a physical medium dependent (PMD) processing portion 114.

The RS processing portion 111 is an interface for connecting a media access control (MAC) layer and a physical (PHY) layer. The RS processing portion 111 may transmit a communication packet received from the multi-buffer unit 130 to the PCS processing portion 112.

The PCS processing portion 112 includes m PCS lanes. The PCS processing portion 112 outputs data provided by the RS processing portion 111 to the PMA processing portion 113 by distributing the data between a plurality of PCS lanes (i.e., the m PCS lanes). The plurality of PCS lanes of the PCS processing portion 112 are virtually distributed lanes.

The PMA processing portion 113 includes n PMA lanes. The PMA processing portion 113 receives m PCS lanes from the PCS processing portion 112, and outputs n PMA lanes. The n PMA lanes are electrical lanes, whereas PMA lanes are virtual lanes. The number of PCS lanes provided by the PCS processing portion 112, i.e., m, may be greater than or the same as the number of PMA lanes output by the PMA processing portion 113. More specifically, in the case of, for example, a 40 G Ethernet, m=n=4, whereas in the case of a 100 G Ethernet, m=20 and n=10 or 4.

The PMD processing portion 114 photoelectrically converts data and a control block received from the PMA processing portion 113 via the n PMA lanes, and transmits the photoelectrically converted data and control block to a receiving party via an optical link including n optical lanes. The link used to transmit the photoelectrically converted data and control block to the receiving party is not limited to an optical link. That is, various other transmission media may be used to transmit the photoelectrically converted data and control block to the receiving party.

There may be a fixed correspondence between PCS lanes, PMA lanes and optical lanes. For example, data distributed into an x-th PCS lane may always be transmitted via a y-th optical lane.

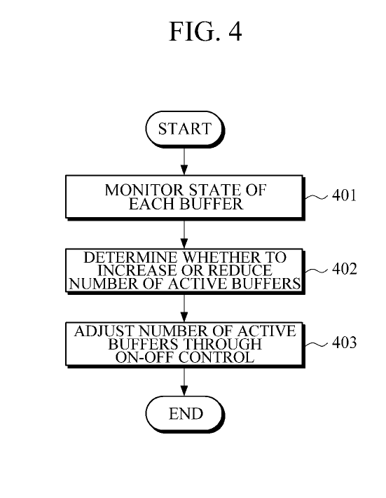

FIG. 4 is a flowchart illustrating an example of a dynamic power-saving method for multi-lane-based Ethernet.

Referring to FIG. 4, the state of each buffer is identified (401). More specifically, the number of buffers currently being active, the number of buffers currently being inactive, the amount of memory space in use and the state of available memory space may be identified.

Thereafter, a determination may be made (402) as to whether to increase or reduce the number of active buffers. More specifically, a determination may be made as to whether to increase or reduce the number of active buffers by comparing the amount of memory space in use of each of the active buffers with a predefined threshold, or based on a predefined criterion regarding the quality of services. For example, if the results of comparison of the amount of memory space in use with the predefined threshold indicate that there is not much available memory space, some of the existing inactive buffers may be switched to an active state. On the other hand, if the results of comparison of the amount of memory space in use with the predefined threshold indicate that there is available memory space, some of the existing active buffers may be switched to an inactive state. The predefined threshold may vary depending on the number and memory capacity of buffers. In a case in which the quality of services is prioritized over energy efficiency, a determination may be made to increase that the number of active buffers. On the other hand, in a case in which energy efficiency is prioritized over the quality of services, a determination may be made to increase the number of inactive buffers.

Thereafter, the number of active buffers may be adjusted through an on-off control (403). More specifically, the number of active buffers may be adjusted in accordance with the determination made in 402. In response to a determination being made to increase the number of active buffers, the number of active buffers may be increased by switching on some of the existing inactive buffers to an active state. On the other hand, in response to a determination being made to reduce the number of active buffers, the number of active buffers may be reduced by switching off some of the existing active buffers to an inactive state. Buffers may be activated or inactivated one after another or all at the same time.

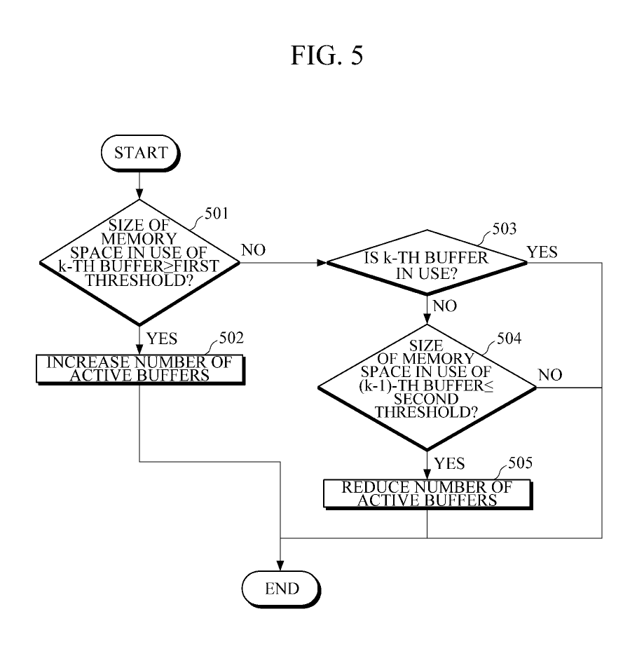

FIG. 5 is a flowchart illustrating an example of a method to determine whether to increase or reduce the number of buffers.

Referring to FIG. 5, the size of memory space in use of a k-th buffer, which is the most recently activated buffer among a plurality of buffers, is compared with a first threshold (501). More specifically, the size of memory space in use of the k-th buffer may be identified, and may be compared with the first threshold. The first threshold may be set in consideration of the memory capacity of each active buffer. The same threshold may be set for all buffers, or different thresholds may be set for different buffers.

In response to the size of memory space in use of the k-th buffer being the same as or greater than the first threshold, a new buffer is added (502). More specifically, in response to the size of memory space in use of the k-th buffer being the same as or greater than the first threshold, a determination is made that an additional buffer is needed, and one of the existing inactive buffers may be switched to an active state. An input communication packet may be sequentially stored in a plurality of buffers in the order in which the buffers are activated. Accordingly, in response to the size of memory space in use of the k-th buffer being the same as or greater than the first threshold, a determination may be made that there is not much available storage capacity in the whole activated buffers, and available memory space may be secured by switching an existing inactive buffer to an active state before the saturation of all memory space.

In response to the size of memory space in use of the k-th buffer being less than the first threshold, a determination may be made (503) as to whether the k-th buffer is empty. More specifically, when the size of memory space in use of the k-th buffer is less than the first threshold, there may be no communication packet stored in the k-th buffer, and thus, a determination needs to be made as to whether the k-th buffer is empty. If the k-th buffer is determined to be in use, a current number of active buffers may be maintained.

In response to a determination being made that the k-th buffer is empty, a determination may be made (504) as to whether the size of memory space in use of a second most recently activated buffer, i.e., a (k-1)-th buffer, is less than a second threshold. If there is not much available memory space in the (k-1)-th buffer, the k-th buffer may be maintained to be active even if the k-th buffer is empty. The second threshold may have the same value as or a different value from the first threshold.

In response to the amount of memory space in use of the (k-1)-th buffer being less than the second threshold, the k-th buffer is switched to an inactive state (505). More specifically, in a case in which the amount of memory space in use of the (k-1)-th buffer is less than the second threshold, a determination may be made that there is available memory space in the whole buffer unit. Accordingly, by switching the k-th buffer to an inactive state, it is possible to reduce the number of buffers in use and thus to reduce the power consumption of the whole buffer unit.

The embodiment illustrated in FIG. 5 is exemplary, and thus, the present inventive concept is not limited thereto. In the embodiment illustrated in FIG. 5, a single buffer is switched to an active or inactive state. Alternatively, two or more buffers may be activated or inactivated at the same time. Operations 501 and 502 and operations 503, 504 and 505 are illustrated in FIG. 5 as a series of steps of a single method, but may be implemented as separate methods.

According to the present inventive concept, it is possible to reduce energy consumption and minimize the deterioration of the performance of a network by performing an on-off control on the buffers of multiple lanes. Embodiments of the present inventive concept can be applied to nearly all multi-lane-based Ethernet networks.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A power-saving apparatus for multi-lane-based Ethernet, comprising:
a multi-lane communication unit configured to distribute an input communication packet between a plurality of transmission lanes, photoelectrically convert the input communication packet and transmit the photoelectrically-converted communication packet;
a multi-buffer unit configured to comprise one or more buffers, store the input communication packet in each active buffer and transmit the input communication packet to the multi-lane communication unit; and
a control unit configured to monitor the multi-buffer unit, compare the size of memory space in use of the multi-buffer unit with a predefined threshold and switch the one or more buffers to an active or inactive state based on the results of the comparison.

2. The power-saving apparatus of claim 1, wherein the multi-buffer unit is further configured to switch the one or more buffers to the active or inactive state through an on-off control.

3. The power-saving apparatus of claim 1, wherein the multi-lane communication unit is further configured to adjust the number of available transmission lanes by performing an on-off control on the transmission lanes in consideration of network traffic circumstances.

4. The power-saving apparatus of claim 1, wherein the one or more buffers have different memory capacities.

5. The power-saving apparatus of claim 1, wherein the multi-buffer unit is further configured to compare the size of memory space in use of a most recently activated buffer, among the one or more buffers, with the predefined threshold and to switch an existing inactive buffer to the active state in response to the results of the comparison indicating that the size of memory space in use of the most recently activated buffer is the same as or greater than the predefined threshold.

6. The power-saving apparatus of claim 1, wherein the multi-buffer unit is further configured to compare the size of memory space in use of a most recently activated buffer, among the one or more buffers, with the predefined threshold, to determine whether the most recently activated buffer is empty in response to the results of the comparison indicating that the size of memory space in use of the most recently activated buffer is less than the predefined threshold, and to inactivate the most recently activated buffer in response to a determination being made that the most recently activated buffer is empty.

7. The power-saving apparatus of claim 1, wherein the multi-buffer unit is further configured to queue the input communication packet via a most recently activated buffer, among the one or more buffers, and use a single queue obtained by sequentially connecting multiple queues.

8. A power-saving method for multi-lane-based Ethernet using one or more buffers, comprising:
monitoring the state of each of the buffers and the amount of memory space in use of each active buffer;
determining whether to increase or reduce a number of active buffers among the one or more buffers; and
adjusting the number of active buffers based on the results of the determining.

9. The power-saving method of claim 8, wherein the determining comprises comparing the size of memory space in use of a most recently activated buffer among the one or more buffers with a first threshold.

10. The power-saving method of claim 9, wherein the determining further comprises, in response to the size of memory space in use of the most recently activated buffer being greater than the first threshold, determining to activate an existing inactive buffer among the one or more buffers.

11. The power-saving method of claim 9, wherein the determining further comprises:
in response to the size of memory space in use of the most recently activated buffer being less than the first threshold, determining whether the memory of the most recently activated buffer is empty;
in response to the memory of the most recently activated buffer being empty, comparing the size of memory space in use of a second most recently activated buffer among the one or more buffers with a second threshold; and
in response to the size of memory space in use of the second most recently activated buffer being less than the second threshold, determining to inactivate the most recently activated buffer.

12. The power-saving method of claim 8, wherein the one or more buffers have different memory sizes.

13. The power-saving method of claim 8, wherein the one or more buffers are activated or inactivated through an on-off control.
